(19) United States
(12) Patent Application Publication
(10) Pub. No.: US 2021/0217024 A1
(43) Pub. Date: Jul. 15, 2021

(54) System and Method of Consolidating Identity Services

(71) Applicant: CrowdBlink Technologies, Inc., Toronto (CA)

(72) Inventors: Carlo Chiarello, Toronto (CA); Rina Whittaker, Pickering (CA)

(21) Appl. No.: 17/149,861

(22) Filed: Jan. 15, 2021

Related U.S. Application Data
(60) Provisional application No. 62/961,642, filed on Jan. 15, 2020.

(51) Int. Cl. G06Q 20/40

(52) U.S. Cl. CPC G06Q 20/40145; G06Q 20/4014

(57) ABSTRACT

A method is provided for using consolidated approaches for validating the identity of a user. A request is received to match the user's identity to previously enrolled particulars of the user. After determining that the user's identity has not yet been validated, at least one identity proofing solution is provided as an alternative to self-validation of the user's identity for the request. The identity proofing solution provider is queried to confirm the user's identity by providing the requested identity and an authentication token received from the user. On receipt of a confirmation, the user's identity is validated to the requestor. A corresponding system is also provided.

### FIELD OF INVENTION

The field of invention is generally related to systems and methods of consolidating identity services that can verify a user's identity directly or indirectly and in particular is related to providing facilitating communication between users, applications and identity solutions.

### BACKGROUND OF THE INVENTION

Digital channels are leveraged by users for almost all parts of modern life. Users expect real-time, mobile and frictionless experiences that are safe and secure. The resulting need to corroborate the identity of customers, users, buyers, sellers, citizens, partners and employees through remote interactions continues to grow. Additionally, while traditionally these actions were limited to online transactions, the growing use of technology in all facets of life requires validation of digital identities for physical, real world actions as well.

Traditionally, online identity has been managed with usernames, email addresses, passwords, with out-of-wallet knowledge questions or memorable personal data leveraged for ‘identity proofing’. However due to the significant rise in data breaches and corresponding theft of personally identifying information (PII) through hacking, malware and social engineering, stronger methods are required to sufficiently corroborate individuals online. Stricter protocols and regulatory bodies such as the General Data Privacy Regulation (GDPR) and California Consumer Privacy Act (CCPA) are shaping how personal data is managed and returning control back to consumers

The concept of a user identity has evolved to a much more complex level and involves layers of information and verification, including physical identification documents, self captured photos, biometrics, and more. Together, these layers of identity allow for organizations to implement verification and authentication processes like identity proofing to secure users and their data.

Advanced forms of identity proofing require users to present identity documents as part of an onboarding process as proof of their real-world identity. A growing number of providers enable applications to embed document validation capabilities into their enrollment processes. However regional support, document type and document version support vary substantially by provider. Businesses do not always know where their users are coming from therefore multiple solutions and multiple technology implementations may be required depending on the target audience, especially for organizations with a global reach.

Coupling biometrics with identity document verification provides another level of identity proofing. Biometrics collected at enrollment and during subsequent authorization attempts enables a higher degree of trust in the validity and uniqueness of the identity being claimed. Additionally biometrics are rapidly becoming mainstream through mass-market adoption of mobile devices and PCs equipped with biometric sensors for password enhancement. The consumer demand for balance between convenience and security is driving businesses to adopt biometrics.

Ultimately as regulatory bodies and consumer expectations drive organizations to return control over their digital identity to the user, a corresponding shift is occurring in how identities are shared: moving away from the earlier centralized and federated solutions to the greater expansion of user-centric, and self-sovereign identity solutions.

Increased industry fragmentation and competition for the consumer's digital identity is making the task even harder as it implies having to deal with more than one entity to arrive at a high degree of confidence that the digital identity provided is indeed the person performing an action. With the proliferation of global and national identity programs and innovations initiated by governments, financial institutions, technology providers and other over-the-top organizations, no one-size-fits-all solution exists. The diversity of market needs and solutions across continents, countries and industries amplifies an already hyperactive ecosystem. As a result, consumer technologies—especially those who serve multiple markets—need to support multiple identity solutions to capture audiences based on the solutions those audiences are likely to have adopted.

For example, in global events management, it has been conventional practice to use paper-based whitelists and blacklists for admission decisions and anti-scalping protocols. It would be desirable to use a “best of breed” approach with respect to available and relevant identity proofing solutions in order to facilitate validation of user information using digital tools that enhance confidence.

### SUMMARY

Broadly speaking, the present invention relates to a system and method which consolidates and facilitates communication between users, applications and identity solutions and allows selective but limited information and authentication details to be received in order to make and communicate a validation decision with respect to user identity without duplicating or unnecessarily circulating personal information of a user.

According to a first aspect of the invention, a method is provided for using consolidated approaches for validating the identity of a user. A request is received to match the user's identity to previously enrolled particulars of the user. After determining that the user's identity has not yet been validated, at least one identity proofing solutions is provided as an alternative to self-validation of the user's identity for the request. The identity proofing solution provider is queried to confirm the user's identity by providing the requested identity and an authentication token received from the user. On receipt of a confirmation of the user's identity, the user's identity is validated to the requestor.

The identity proofing solution may be selected by the user. The identity proofing solution may be selected by the requestor or may be selected by the system. Multiple identity proofing solutions may be selected and queried to enhance certitude. For instance, if no aspect of the user's identity has previously been validated, multiple identity proofing solutions may be needed to achieve a desired certitude. Three separate solutions may provide 80% certainty, versus one providing only 70% certainty. As the system gathers validation with respect to various credentials (and potentially biometric or other unique identifiers) of the user, the starting level of certainty may increase.

The method may also include testing for the presence of the confirmed user by receiving at least one identifier from the user, and associating the identifier with the confirmed user. The identifier may be a biometric identifier.

In one embodiment, the request is with respect to an event. In this case, the previously enrolled particulars may pertain to a ticket or transaction associated with the event.

Preferably, the identity proofing solution(s) are pre-selected having regard to user provided information, information from or detected by the user's device, location of the user, location of the requestor, or security policies of the requestor (e.g. security policies of the event). These factors may be weighted. For instance, the weighting may depend on attributes of the user, such as driver's license or passport origination, place of birth, or other factors such as the location of an event (geography), and may depend on tolerances of the requestor or other localized policies or legal requirements.

Preferably, the identity proofing solutions are self-sovereign or user-centric identity proofing solutions.

The requestor may be the user him/herself or may be a third party seeking to validate the user for a decision-making purpose (e.g. with respect to an admission or transaction decision).

Preferably, the previously enrolled particulars include name of the user, and at least one of the following with respect to that user: age, address, date of birth, phone number or device ID, ticket information, financial or payment information, health status or vaccination status.

Signature, PIN or password may be used in simple forms of authentication token. In more sophisticated embodiments, the authentication token may apply a standard such as a FIDO standard or an EMV standard.

In order to preserve privacy, preferably, the confirmation is sent to the requestor without providing the requestor with all of the information about the user held by the selected identity proofing solution. In other embodiments, limited information is released to the requestor. This limited information may for example be based on the consent that has been provided by the user.

Various forms of biometric identifier may be used. Examples of physical identifiers include: fingerprint, retina scan, palm vein scan, facial recognition scan, DNA scan, palm print, hand geometry scan, iris recognition scan, voiceprint, and odour/scent scan. Examples of behavioural identifiers include: typing rhythm, gait, and speech pattern. Combinations may also be used.

In some embodiments, the biometric identifier is of a type selected by the requestor. In other embodiments, the biometric identifier is selected based on detected capabilities of the user's device or devices connected to the user's device (e.g. detection of available camera capabilities or links to other types of sensors or scanners).

Various follow-on steps are possible following validation. For instance, the validation may lead to automatically allowing admission of the user to a place or event. The validation may lead to confirming or completing a proposed transaction. The validation may lead to adding the user to a whitelist. (Failed validation may lead to adding the user to a blacklist.) The validation may lead to automatically granting a particular status to the user (e.g. VIP status, qualified buyer status). The validation may lead to automatically removing a restriction on the user following validation (e.g. removing a quarantine requirement if vaccination or immunity status is validated, removing an age-restriction on the user to allow participation in restricted zones, activities or transactions).

According to a second aspect of the invention, a method is provided for using consolidated approaches for validating the identity of a user. A request is received to match the user's identity to previously enrolled particulars of the user. After it is determined that the user's identity has not yet been validated, and it is determined that the user is not enrolled with any of a pre-selected list of identity proofing solutions, the user is prompted to provide a photograph or scan of an identification credential (e.g. government ID card, passport) selected from a pre-approved list of identification credentials. The user is prompted to provide a selfie (e.g. a contemporaneous selfie). After the selfie is matched to a photograph on (or associated with) the identification credential within a threshold of confidence, the user's identity is validated.

According to a third aspect of the invention, a system is provided for using consolidated approaches for validating the identity of a user. The system includes a requestor module, a consolidation module, and a user module. The requestor module is programmed for receiving a request from a requestor to match the user's identity to previously enrolled particulars of the user. The consolidation module is programmed for determining that the user's identity has not yet been validated, and querying at least one identity proofing solution selected from a pre-populated list. The user module is programmed for receiving an authentication token for the identity proofing solution in order to allow remote confirmation of the user's identity.

The user module may be further programmed for receiving an identifier from the user to be associated with the identity of the user. This may be a biometric identifier.

Preferably, the consolidation module is programmed for communicating a validation decision to the requestor without providing the requestor with information about the user held by the selected identity proofing solution.

Preferably, the system can verify a user's identity directly or indirectly by providing a single point of contact to facilitate communication between users, applications and identity solutions. In one embodiment the user logs in or creates an account in an application preferably installed on a mobile device. The app may preferably be associated with the system and runs on a mobile device like a smartphone.

Preferably, the system provides the user with the option to validate identity through the system or to select an existing third-party identity proofing and corroboration solution that integrates with the system e.g. a self-sovereign or user centric identity provider.

In one embodiment the user has the option to validate identity through the system (self-validation) or alternatively can select an existing third-party solution for self-sovereign and/or user centric identity provider that is integrated with the system.

In one embodiment the user may choose to self-validate their identity through document verification e.g. by providing government issued identity documents like a driver's license or a passport directly with the system by providing an image of the selected identity document via the app associated with the system and preferably installed on the mobile device e.g. a smartphone of the user.

In one embodiment the user provides a picture of their ID e.g. a license or a passport taken via the camera on the device where the application is installed and a selfie also taken via the camera on the device where the application is installed.

In one embodiment the system may provide the user with the option to use one of the several government issued identity documents. The government issued identity documents may include but are not limited to a passport, a driver's license, an identity card, national ID and national insurance numbers. It is to be noted that this list of identity documents is exemplary and not exhaustive or limiting as these identity documents can take many different forms and may be referred to differently in different places.

In one embodiment the user may opt to use a supported/existing identity proofing and corroboration solutions and then authorizing to share their digital identity. Such solutions may include but are not limited to self-sovereign and user centric identity providers.

Self-Sovereign Identity (SSI) enables users to own, control, and present their identity data as needed while enabling service providers to securely validate and trust the identity claims made by the users. SSI extends individuals or organizations sole ownership of their digital and analog identities, and control over how their personal data is shared and used.

In one embodiment the user logs in or creates an account in an application associated with the system. The system determines that the user's identity has not been validated. This determination may be made by searching the records and/or database associated with the system where such information is stored. If no records are found that match the user then the user is prompted to provide identity information for validation.

In one embodiment the system analyzes criteria such as user provided information (such as country), information from user's device (such as location), location of events and security policies to determine identity proofing options and presents these identity proofing options to the user.

In one embodiment a user initiates action e.g. access control or payment and the system determines what information is required from the user in order to process the user initiated action.

In one embodiment, EMV 3DS messages may be used to pass FIDO (Fast IDentity Online) authenticator attestation data and signatures in a manner that is both scalable and interoperable across the EMV payments ecosystems and other authentication needs as envisioned in this disclosure.

In one embodiment using FIDO authenticator attestation data set, merchants can deliver a structured set of data elements and present the card issuer with a consistent set of values for the same user or device along with other data they would receive as part of an EMV 3DS transaction, which reduces the need for repeated consumer authentication.

In one embodiment, a scenario could include receiving additional data from FIDO authentications that issuers could cryptographically verify, and using FIDO Authentication as an EMV 3DS challenge method.

In one embodiment the system prompts the user for biometric authorization. Biometric information may include but is not limited to a fingerprint, a retina scan etc. User then provides the requisite biometric e.g. by placing the index finger on or in the fingerprint scanner.

In one embodiment the system confirms biometric identity of the user and processes user initiated action e.g. access control or financial transaction. In one embodiment the system may charge the user for providing and storing the identity validation services and the system completes a financial transaction to obtain user funds from the one or more financial institution(s) specified by the user.

It is an objective of the present invention to automate the tedious and manual task of keeping identity information up to date and consistent given that the user identity information that may exist in multiple different locations, with segmented data

It is an objective of the present invention to automate and improve this process through a singular point of contact that consolidates the different identity gateways and enables a user to keep information consistent and fully synchronized from one source to another.

### BRIEF DESCRIPTION OF THE FIGURES

FIG. 1 is a network diagram of an embodiment of a system for identity consolidation services.

FIG. 2 is a flow diagram of a sample process for identity proofing.

FIG. 3 is a flow diagram of a sample process for self-validation of identity through ID (continuation of a first branch of FIG. 2).

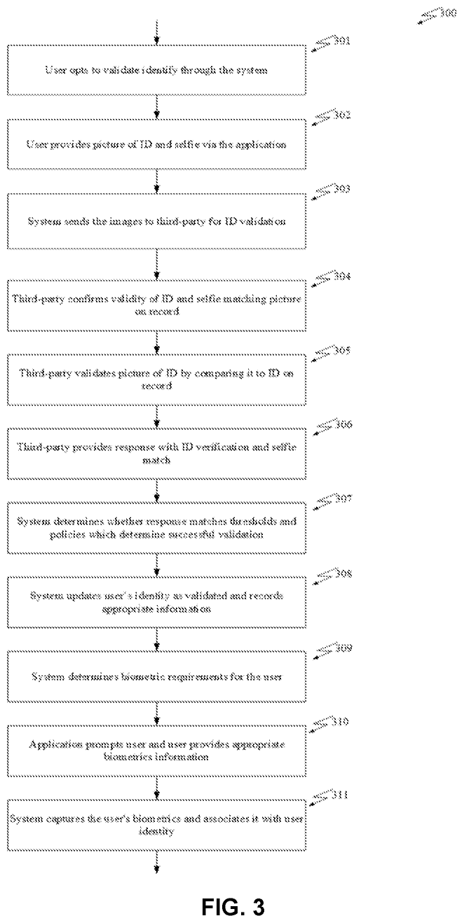

FIG. 4 is a flow diagram of a sample process for identity validation through a selected identity proofing and corroboration solution (continuation of a second branch of FIG. 2).

FIG. 5 is a flow diagram of a sample process for determining available and applicable identity proofing options.

FIG. 6 is a flow diagram for applying identity proofing processes in a transaction for access control or payment.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including in object-oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, TypeScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU or GPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example, and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a standalone computer, a server, a server farm, virtual machines, cloud computing, on the mobile device as a stand-alone software package; partly on the mobile device and partly on a remote computer or remote computing device or entirely on the remote computer or server or computing device. In the latter scenario, the remote computers may be connected to each other or the mobile devices through any type of network, including a local area network (LAN) or a wide area network (WAN), or the connection may be made to the internet through a mobile operator network (e.g. a cellular network); WiFi, Bluetooth etc.

The servers and processors may be physical or virtual e.g. implemented in a cloud architecture. The processing may be accomplished using a Central Processing Unit (CPU) or a Graphic Processing Unit (GPU).

Modern GPUs are very efficient at manipulating computer graphics and image processing. Their highly parallel structure makes them more efficient than general-purpose Central Processing Units (CPUs) for algorithms that process large blocks of data in parallel.

Architecturally, the CPU is composed of just a few cores with lots of cache memory that can handle a few software threads at a time. In contrast, a GPU is composed of hundreds of cores that can handle thousands of threads simultaneously. The ability of a GPU with 100 plus cores to process thousands of threads can accelerate computation requiring parallel processing. Additionally, a GPU may achieve this acceleration while being more power- and cost-efficient than a CPU.

One advantage of the present methods and systems for identity validation is reduced latency and quicker automated decision-making, without reliance on human decision-makers.

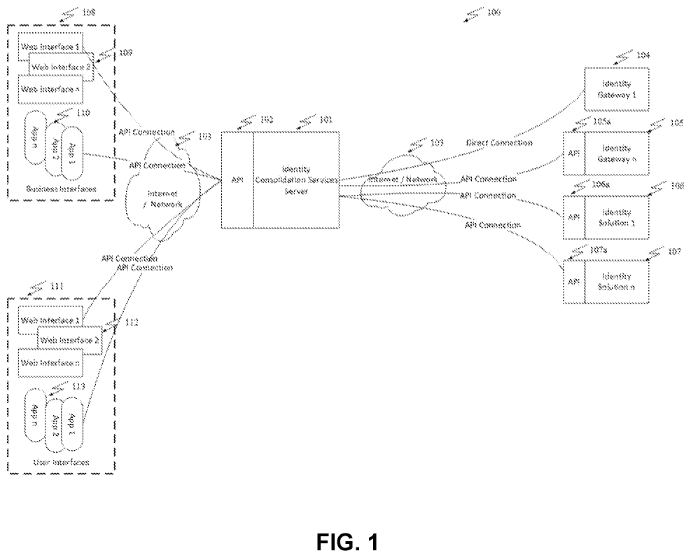

FIG. 1 shows an exemplary configuration of a system 100, according to an embodiment of the present invention. The system 101 can consolidate different ID Gateways and provide a singular consolidated interface to applications and users.

FIG. 1 shows an exemplary configuration of a system 100, according to an embodiment of the present invention. The system and method can verify a user's identity directly or indirectly through consolidation of identity services (e.g. through identity proofing or corroboration service providers).

The system is represented by the Identity Consolidation Services Server 101 which preferably consolidates different identity proofing and corroboration solution e.g. identity gateways, self-sovereign or user centric identity solutions or providers. The system has multiple programmed modules or engines as further set out herein.

The Identity Consolidation Services Server 101 may execute on computing devices like servers that are physical or virtual or a combination hereof. In one embodiment the Identity Consolidation Services Server 101 may execute on a single server while in another embodiment of the invention it may execute on a cluster of servers.

In one embodiment the ID Identity Consolidation Services Server 101 provides a singular consolidated interface to applications and users.

In one embodiment the Identity Consolidation Services Server 101 may expose an Application Programming Interface (API) 102 for facilitating connections and communications with the Business Interfaces and Apps and Consumer/User Interfaces and Apps.

The communication between the different servers, devices, ID Gateways and other entities depicted in the exemplary configuration of the system in FIG. 1 may preferably be conducted over the Internet 103 or other local or distributed network.

The Identity Consolidation Services Server 101 may preferably connect to one or more Identity Gateway1 104 up to Identity Gateway n 105. The Identity Consolidation Services Server 101 may connect to the Identity Gateway1 104 directly over the Internet 103, preferably this connection may be encrypted.

The Identity Consolidation Services Server 101 may connect to the Identity Gateway n 105 using the API to Identity Gateway n 105a over the Internet 103, preferably this connection may be encrypted.

The Identity Consolidation Services Server 101 may connect to the Identity Solution Provider 1 106 using the API to Identity Solution Provider 1 106a.

The Identity Consolidation Services Server 101 may connect to the Identity Solution Provider n 107 preferably using the API to Identity Solution Provider n 107a.

Business Interfaces 108 that may include but are not limited to Web Interface 1, Web Interface 2 up to Web Interface n 109 and different Business Apps App 1, App 2 up to App n 110 running on different devices, may preferably connect to the Identity Consolidation Services Server 101 using the API 102. Using one or more of the Business Interfaces 108, a business may communicate with the Identity Consolidation Services Server 101 to verify the identity of its users.

The Business Web Interfaces 109 may preferably be on a computing device, a server, a mobile device, a virtual server that is connected to other hardware e.g. biometric scanners.

The Business Apps 110 may execute on Smartphones, tablets, and may be coded to execute on different operating systems like iOS and Android.

Consumer/User Interfaces 111 that may include but are not limited to Web Interface 1, Web Interface 2 up to Web Interface n 112 and different User Apps App 1, App 2 up to App n 113 running on different devices, may preferably connect to the Identity Consolidation Services Server 101 using the API 102. The user devices and apps may be further connected with other devices to provide localized collection of, for example, biometric identifiers.

Using one or more of the Consumer/User Interfaces 111, a consumer/user may communicate with the Identity Consolidation Services Server 101 to verify their identity.

The Consumer/User Web Interfaces 112 may preferably be on a computing device, a server, a mobile device, a virtual server that is connected to other hardware e.g. biometric scanners.

The Consumer/User Apps 113 may execute on Smartphones, tablets, and may be coded to execute on different operating systems like iOS and Android.

In one embodiment the identity service/solution may be implemented on a physical device e.g. a smartphone. In such an embodiment the app associated with the system and method of invention may preferably be in communication with the user's device technology. In such an embodiment the system is not communicating with an identity service via the internet/network but may preferably communicate directly with the device operating system and device storage, directly with an application on the device or through a peer to peer connection e.g. using Bluetooth.

Identity proofing or identity verification is the process to verify and authenticate the identity of legitimate customers/users. Identity proofing enables rightful users to access the digital and/or physical spaces, and perform digital and physical actions that require security and verification and it prevents fraudulent users from accessing these sensitive assets whether physical or digital. For identity proofing to be successful, validation of three aspects of an identity is necessitated: (1) the user's real-world identity, (2) the user's digital identity, and (3) the identity claimed.

The process of identity proofing is critical in enabling organizations to protect themselves and their users from security threats. By opting to validate the identity of a user before issuing an account, or by incorporating an added layer of authentication at every authorization, organizations strive to ensure that they are only allowing trusted users to access their systems, physical premises and perform other physical and digital actions. This may be used to guide automated decision making for transactions (including admission transactions), and other permissions and removal of restrictions.

Relying on traditional methods of proving an individual's identity through static data, knowledge-based user attributes and out of wallet questions is no longer sufficient. Modern day identity proofing and corroboration requires more rigor and leverages validation of legal identity documents, liveness detection, selfie-to-photo ID comparisons, biometrics and more.

Additionally, as the number of global initiatives, national ID programs, identity service providers and the pace of innovation in identity models and mechanisms increases, so does the competition for the consumer. To enable users to self-verify and make secure authentication and authorizations without compromising user experience, organizations will need to support solutions based on what their target audience is likely to adopt.

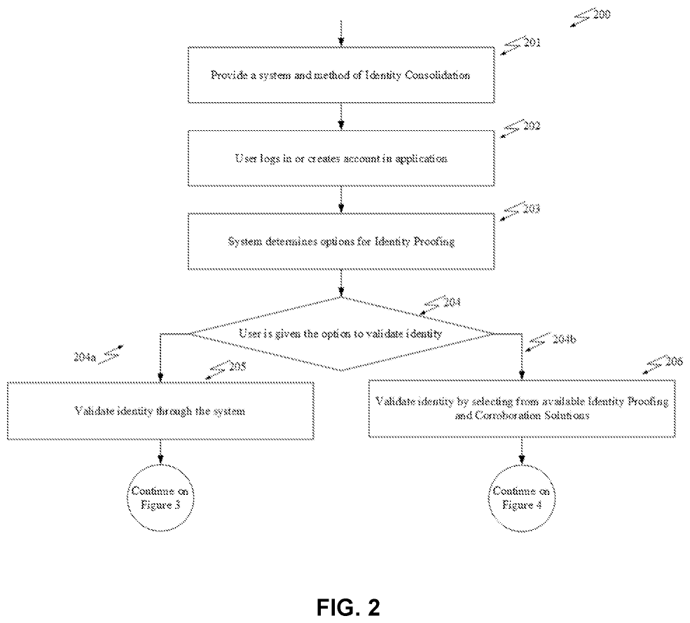

FIG. 2 shows one aspect of the method 200. A system and method is provided for identity consolidation 201 that can verify a user's identity directly or indirectly.

The user logs in or creates account in application 202, such as an application installed on user's device, such as a mobile device.

An app or an application is a type of software that allows a user to perform specific tasks. Applications for mobile devices like phones and tablets are called mobile apps while those for desktop or laptop computers are referred to as desktop applications. When a user runs an application, it executes within the operating system installed on the device. Mobile apps can be downloaded from an app store like Apple AppStore, Google Play Store or Microsoft Store. Apps can be free or may cost a user to download or use e.g. on a subscription basis. There may be many other app stores maintained and managed by other entities like device manufactures, Samsung Appstore, or vendors like Amazon Appstore. The invention is not limited to the examples cited here.

Native apps are created for one specific platform or operating system. Hybrid apps are combinations of both native and web apps, but wrapped within a native app, giving it the ability to have its own icon or be downloaded from an app store.

A web-based app is coded in HTML5, CSS or JavaScript and requires intent access for proper behavior and user-experience. Such apps may require minimum memory space in devices compared to native and hybrid apps.

A mobile device is a computing device that enables a user to engage with an application (app) and may include a memory for storing a control program and data, and a processor (CPU) for executing the control program and for managing the data, which includes user data resident in the memory and includes buffered content. Mobile devices may run mobile operating systems that allow third-party apps specialized for productivity, social interaction or gaming capabilities to be installed and run. Mobile devices may be coupled to a video display such as an inbuilt screen, or an external screen like a television or a monitor, or other type of visual display. Such devices are typically powered by inbuilt rechargeable batteries.

Mobile devices may connect to the Internet and interconnect with other devices such as car entertainment systems or headset via WiFi Bluetooth, cellular networks or Near Field Communications (NFC). Microphones, speakers and integrated cameras enable them to communicate by placing and receiving voice and video telephone calls, interact with video games and Global Positioning Systems GPS) capabilities.

Mobile devices may incorporate CPU, GPU, inbuilt and expandable memory storage, touchscreen, gyroscope, GPS, one or more cameras, fingerprint scanner, WiFi, Bluetooth, NFC (both vicinity and proximity based).

Smartphones, tablets, Smartwatches, eReaders, Bluetooth headsets, Pocket PCs, cell phones etc. are examples of newer types of mobile devices, while PDA—Personal Digital Assistant, Palmtop etc. are examples of older types of such devices. Other wearable devices or devices embedded in other systems (e.g. automotive) may also fall into this category.

The system determines options for identity proofing 203. In one embodiment system determines options for Identity Proofing.

The user may be given the option to self-validate identity through the system or select an existing identity proofing and corroboration solution e.g. a self-sovereign or user centric identity provider 204. In one embodiment the system provides the user with the option to validate identity through the system 204a or select an existing self-sovereign/user centric Identity Provider 204b.

The user can self-validate identity through the system 205, for example, through document verification e.g. by providing government issued identity documents like a driver's license or a passport.

The user can alternatively opt to validate identity by selecting from available identity proofing and corroboration solutions 206. The user may need to authorize the selected identity proofing solution to share their digital identity (or to confirm identity without sharing specifics). Such solutions may include but are not limited to self-sovereign and user centric identity providers.

Self-Sovereign Identity (SSI) enables users to own, control, and present their identity data as needed while enabling service providers to securely validate and trust the identity claims made by the users. SSI extends individuals or organizations sole ownership of their digital and analog identities, and control over how their personal data is shared and used.

In the SSI method of identity verification an identity claim is an assertion made by a person or a business e.g. name or age claim; a proof is some form of document that provides evidence for the claim e.g. a driver's license or a passport and an attestation is when a third party validates that according to their records, the claim made by the user is true.

In the SSI method of identity verification, a user's identity is validated by accepting a verifiable digital credential issued to the user by a competent and trusted identity authority. This adds a layer of security and flexibility allowing the identity holder to only reveal the necessary data for any given transaction or interaction. A non-digital equivalent of this would be paper-based identities issued by different levels of governments e.g. passports, driver's license or birth certificates and are used as a proof when needed by physically showing these to the verifier.

User-Centric and self sovereign identity services may use blockchain/distributed ledger technology.

The user may opt to self-validate identity through the system 301, for example, using government issued identity documents like driver's license or a passport.

In this case, the user may provide a picture of the user's ID and a selfie taken via the application 302. For example, these may be captured via the camera on the device where the application is installed.

In one embodiment the system may provide the user with the option to use one of several government issued identity documents. The government issued identity documents may include but are not limited to a passport, a driver's license, an identity card, national ID and national insurance numbers. It is to be noted that this list of identity documents is exemplary and not exhaustive or limiting as these identity documents can take many different forms and may be referred to differently in different places. The type of identity documents requested or accepted may be determined having regard to a detected (or previously known) location of the user or the user's device.

The system may issue a decision based on the files received, or may send the images to a third-party for ID validation 303.

In one embodiment the interaction between the system and the third-party ID validation system may be encrypted to protect the data being exchanged.

If used, the third-party may confirm validity of ID and selfie matching picture on record 304. In one embodiment the third-party validates picture of ID by comparing it to ID on record.

If used, the third-party may confirm validity of the picture of ID by comparing it to ID on record 305. In one embodiment the third-party validates picture of ID by comparing it to ID on record.

The third-party (if used) provides a response with ID verification and selfie match 306.

Preferably, the system determines whether response matches thresholds and policies which determine successful validation 307. In one embodiment the system determines whether response matches thresholds and policies which determine successful validation. For instance, the response from the third-party may be in the form of a confidence measure or score of likely match. This is then gauged against a pre-determined acceptable threshold for validation.

The system updates the user's identity as validated and records appropriate information 308. In one embodiment the system updates user's identity as validated and records appropriate information in an encrypted form or uses blockchain as a ledger.

The system determines biometric requirements for the user 309.

The application may prompt the user to provide appropriate biometrics information 310, e.g. a fingerprint or a retina scan either via the user's mobile device or via another biometric scanner/reader that is coupled to the system e.g. via a computing device or directly over the network, and associates it with user identity.

The system captures the user's biometrics and associates it with user identity 311.

Biometric identifiers are the distinctive, measurable characteristics related to intrinsic human characteristics used to label and describe individuals. Biometric identifiers may be divided into two categories: physical/physiological identifiers and behavioral identifiers. Physical identifiers are, for the most part, immutable and device independent. Physiological characteristics are related to the shape of the body. Examples include, but are not limited to fingerprint, palm veins, face recognition, DNA, palm print, hand geometry, iris recognition, voice, retina and odour/scent.

Behavioral characteristics are related to the pattern of behavior of a person, including but not limited to typing rhythm, gait, and speech pattern. Behavioral characteristics are also termed behaviometrics. Unlike physical/physiological biometric identifiers, which are limited to a certain fixed set of human characteristics, the behavioral identifiers are more adaptable and can be used where a physical biometric identifier is not available or cannot be acquired easily e.g. tracking an individual in a crowd. In one embodiment the behavioral identifiers may be used in conjunction with another method to increase reliability. In one embodiment the behavioral identifiers may be used to distinguish between a human and a robot and may assist in filtering out spam or detect attempts to brute-force a login and password.

In one embodiment the security policies configured for the event may be used to determine which kind of biometric to use.

In one embodiment the type of biometric information that a user can supply is determined by the user device and the system configuration i.e. availability of external biometric input devices like fingerprint readers and retina scanners.

In one embodiment the nationality, age, gender, location, previous records, credit history, criminal or police records of the user may be used to determine which kind of biometric to use.

In one embodiment fingerprint scanners may be used to collect fingerprints from the users. Fingerprint scanners may be integrated with mobile devices for example smartphones or external where such devices may be connected to other computing devices and coupled to the system. In one embodiment any devices that can be touched, such as a phone screen, computer mouse or touchpad, or a door panel, can also act as fingerprint scanners.

In one embodiment facial recognition and retinal scans may be used for validating user identity. In one embodiment a Smartphones equipped with a camera may be used for identity verification and authentication of a user.

In one embodiment image-based authentication methods may be used including facial geometry recognition, hand geometry recognition, iris or retinal scanning, palm vein recognition, and user ear recognition amongst other techniques.

In one embodiment the system may use voice-based characteristics for recognition to identify and authenticate users.

In one embodiment digital signature scanners may be used for situations where users are already expecting to have to sign their names.

In one embodiment a DNA scan may be used.

eIDV (Electronic Identity Verification) is the use of public and private databases to confirm whether an individual is who they claim to be. eIDV uses personal information such as name, date of birth, Social Security number and address. The result of trying to confirm an individual's identity could be a match, non-match, or partial match.

In one embodiment the Electronic identity verification matches the data provided by a user, such as name, date of birth, address, and SSN, against various databases to determine if there is a match.

In one embodiment personal documents that can serve as sources of data for the verification service including driver's licenses, passports, birth certificates, and citizenship certificates may be used for verification.

In one embodiment various types of databases, both public and proprietary, may be used in el DV, including credit bureau data, police data, and vehicle history data when verifying the identity of a user.

Data that can be used as sources of verification may include change of address data, postal data, property ownership data, direct marketing data, credit bureau data, electoral roll data, utility data (e.g., phone, natural gas, electricity and/or water service), telecommunications records, and government data (such as driver's license, passport, national ID and national insurance numbers). The invention is not limited to the cited examples.

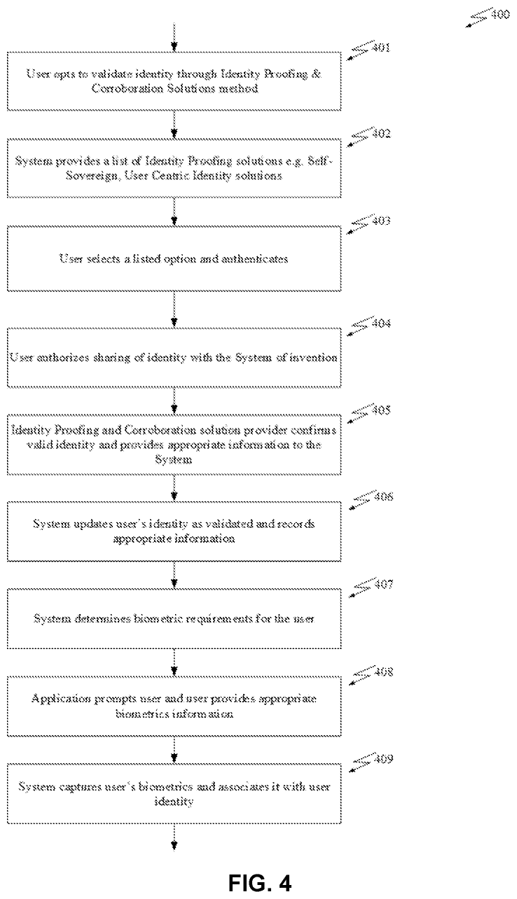

FIG. 4 shows one aspect of the method 400. In one embodiment the system provides the user with the option to use an existing identity proofing provider.

The user opts to validate identity through identity proofing and corroboration solutions method 401. Self-Sovereign Identity (SSI) enables users to own, control, and present their identity data as needed while enabling service providers to securely validate and trust the identity claims made by the users.

The system provides a list of identity proofing solutions e.g. Self-Sovereign, User Centric Identity solutions 402. These may be chosen as being relevant and acceptable based on the user, the location of the user, the location of the event and security policies of the system and event.

In one embodiment the list of identity proofing solutions or providers is determined based on the geographical location of the event, current location of the user and/or the security policies of the system, the event. location, user history etc.

The user selects a listed option and authenticates 403. In one embodiment the user selects a given Self-Sovereign or User Centric Identity provider and authenticates by providing the necessary credentials. For example, this may be an authentication token as described elsewhere herein.

The user authorizes sharing of identity with the system 404.

The identity proofing solution provider confirms valid identity and provides appropriate information to the system 405, preferably in an encrypted form.

The system updates user's identity as validated and records appropriate information 406.

The system determines biometric requirements for the user 407.

The application prompts user and user provides appropriate biometrics information 408, e.g. a fingerprint or a retina scan either via the user's mobile device or another kind of biometric scanner coupled to the system.

The system captures user's biometrics and associates it with user identity 409. The biometric data or profile may be stored in an encrypted form or in a public ledger/blockchain.

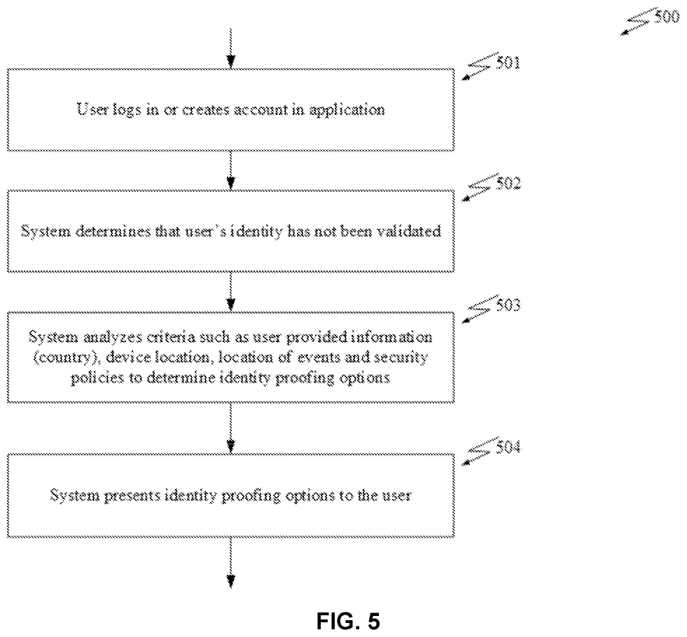

FIG. 5 shows one aspect of the method 500. The user logs in or creates account in application 501.

The system determines that user's identity has not been validated 502. This determination may be made by searching the records and/or database associated with the system where such information is stored and if no records are found that match the user then the user is prompted to provide identity information for validation.

The system analyzes criteria such as user provided information (country), device location, location of events and security policies to determine identity proofing options to present to the user 503.

The system presents identity proofing options to the user 504.

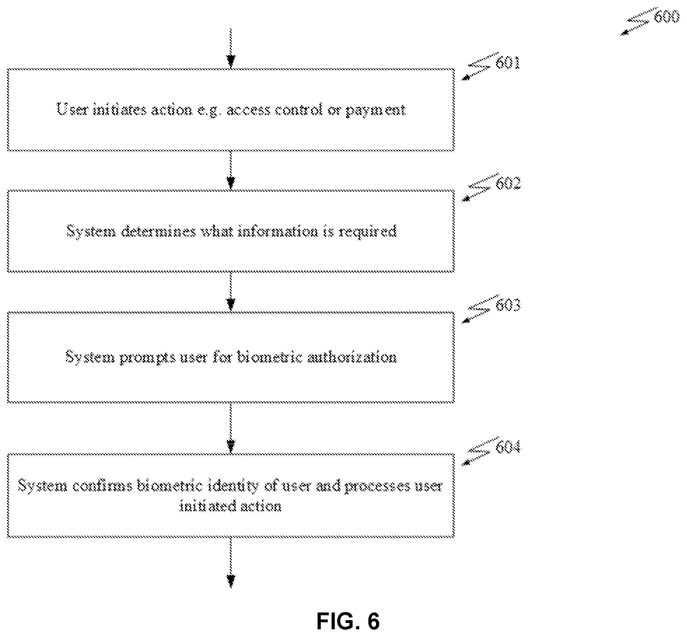

FIG. 6 shows one aspect of the method 600. The user initiates an action e.g. access control or payment 601.

The system determines what information is required 602 from the user in order to process the user initiated action.

The system prompts user for biometric authorization 603. Biometric information may include but is not limited to a fingerprint, a retina scan etc. User then provides the requisite biometric e.g. by placing the index finger on or in the fingerprint scanner.

The system confirms the biometric identity of user and processes user initiated action 604. In one embodiment the system confirms biometric identity of the user and processes user initiated action e.g. access control or financial transaction.

In one embodiment the system may charge the user for providing and storing the identity validation services and the system completes a financial transaction to obtain user funds from the one or more financial institution(s) specified by the user.

A financial transaction is an agreement, or communication, carried out between a buyer and a seller to exchange an asset for payment. Most financial transactions today are conducted digitally using either government backed or cryptocurrencies.

In one embodiment the financial transaction may be conducted in one or more paper or digital currencies e.g. U.S. Dollar (USD), European Euro (EUR), Japanese Yen (JPY), British Pound (GBP), Swiss Franc (CHF), Canadian Dollar (CAD) etc.

In one embodiment the financial transaction may be conducted in one or more cryptocurrencies e.g. Bitcoin, Litecoin, Ethereum, Zcash, Monero etc.

In one embodiment the financial transaction may be composed of one or more transactions made up of one or more paper/digital and/or one or more cryptocurrencies.

A financial transaction may be conducted by use of cheque, draft, money order, wire transfer, email transfer, direct deposit etc. The invention may use any one or a combination of several types and is not limited to this exemplary list.

In one embodiment the user consolidates one or more different identity proofs like photo, voice print, finger print, drivers license, passport, social identity with the system. These identity proofs are stored in an encrypted form in the server(s) of the system and can be used at a later time when a third party requests a proof of identity.

In one embodiment the user when needing to prove identity to a third party, decides which identity credentials to use for identity verification from the system where the user has consolidated one or more identity proofs. As an example, the user may have consolidated identity proofs like finger print, retina scan, voice print, social ID etc. and opts to send a voice print for identity verification when accessing a secure location. Thus the user requests the system to send stored voice print to the system securing the location and the system then sends a tokenized voice print of the user as a proof of identity to the third party.

In one embodiment the system may preferably determine which subset of the several identity proofs that the user has available are more suitable for fulfilling the request by a third party, for example a bank. As an example, the user may have consolidated identity proofs like finger print, retina scan, voice print, drivers license, passport, social identity etc. and the system determines that a finger print scan may be most suitable for conducting a financial transaction as a finger print scanner is available that the user can utilize for providing the specific biometric information and the financial institution e.g. a bank will accept a finger print scan as a proof of the said user's identity.

In one embodiment the system may preferably tokenize the user's identity credentials e.g. the fingerprint scan before sending it to the third party requesting said user's proof of identity.

In another embodiment of the invention the system may only send other agreed upon tokens instead of the tokenized identity credentials i.e. the system vouches for the user, acknowledging to the requesting third party that the user is a credentialed identified person who has consolidated identities with the system. In such a scenario no user identity credentials (finger print, retina scan, voice print, social ID) are shared with the requesting third parties, but instead the system sends its own proof of identity verification as an encrypted token.

In one embodiment, EMV 3DS messages may be used to pass FIDO (Fast IDentity Online) authenticator attestation data and signatures in a manner that is both scalable and interoperable across the EMV payments ecosystems and other authentication needs as envisioned in this disclosure.

3-D Secure is a protocol designed to be an additional security layer for online credit and debit card transactions. The name refers to the “three domains” which interact using the protocol: the merchant/acquirer domain, the issuer domain, and the interoperability domain.

EMV 3-D Secure is a 3-D Secure specification that supports app-based authentication and integration with digital wallets, as well as traditional browser-based e-commerce transactions. EMV 3-D Secure—Protocol and Core Functions Specification take into account these new payment channels and supports the delivery of industry leading security, performance and user experience.

The protocol uses XML messages sent over SSL (Secure Socket Layer) connections with client authentication, this ensures the authenticity of both peers, the server and the client, using digital certificates.

FIDO (Fast Identity Online) authentication is a set of standards for fast, simple, strong authentication. The standards enable phishing-resistant, passwordless, and multi-factor authentication and improves online user experience by making strong authentication easier to implement and use.

FIDO Authentication enables password-only logins to be replaced with secure and fast login experiences across websites and apps. FIDO Authentication is characterised with passwordless authentication, second-factor authentication and multifactor authentication using verification process like security key, facial recognition, fingerprint, voice either individually or in any number of combinations.

In one embodiment using FIDO authenticator attestation data set, merchants can deliver a structured set of data elements and present the card issuer with a consistent set of values for the same user or device along with other data they would receive as part of an EMV 3DS transaction, which reduces the need for repeated consumer authentication.

In one embodiment using FIDO Authentication data in EMV 3DS messages additional data from FIDO authentications can be sent to issuers that they can then cryptographically verify, using FIDO Authentication as an EMV 3DS challenge method.

In one embodiment the system automatically narrows down from the available set of user identifiers, a subset that a user can send or a user can further narrow this subset to send to the third-party seeking user identity verification.

In another embodiment the system may preferably automatically narrow down from the available set of user identifiers a subset and automatically send these to the third-party seeking user identity verification.

In another embodiment the system may preferably choose different subsets for different third-parties based on weighted factors.

In one embodiment there may be a measure of certitude of the user authentication, i.e. how certain is the system with the user being who the user claims to be. In such an embodiment when the user is not verified by the system of invention, the certitude level may be considered to be zero. As the system gathers one or more user identifiers like for example driver's license, passport, country issuing the passport, place of birth etc. the level of certitude continues to increase. With the system gathering biometric data like finger prints, retina scans, DNA etc. the level of certitude continues to increase tending closer to a hundred percent (but perhaps never reaching that final limit).

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and applicable equivalents.

What is claimed is:

1. A method for using consolidated approaches for validating the identity of a user, comprising:
receiving a request from a requestor to match the user's identity to previously enrolled particulars of the user;
determining that the user's identity has not yet been validated;
providing at least one pre-selected identity proofing solution as an alternative to self-validation of the user's identity for the request;
querying the identity proofing solution provider to confirm the user's identity by providing the requested identity and an authentication token received from the user;
on receipt of confirmation, validating the user's identity to the requestor.

2. The method of claim 1, wherein the identity proofing solution is selected by the user.

3. The method of claim 1, wherein multiple identity proofing solutions are selected and queried to enhance certitude.

4. The method of claim 1, further comprising:
testing for the presence of the confirmed user by receiving at least one identifier from the user; and
associating the identifier with the confirmed user.

5. The method of claim 4, wherein the identifier is a biometric identifier.

6. The method of claim 1, wherein the request is with respect to an event, and the previously enrolled particulars are with respect to a ticket or transaction associated with the event.

7. The method of claim 1, wherein the at least one identity proofing solution is pre-selected having regard to factors including user provided information, information from or detected by the user's device, location of the user, location of the requestor, or security policies of the requestor.

8. The method of claim 7, wherein the factors are weighted.

9. The method of claim 1, wherein the identity proofing solutions are self-sovereign or user-centric identity proofing solutions.

10. The method of claim 1, wherein the requestor is the user.

11. The method of claim 1, wherein the previously enrolled particulars include name of the user, and at least one of the following with respect to the user: age, address, date of birth, phone number or device ID, ticket information, financial or payment information, health status or vaccination status.

12. The method of claim 1, wherein the authentication token comprises a FIDO standard authentication token, or an EMV standard authentication token.

13. The method of claim 1, wherein the confirmation is sent to the requestor without providing the requestor with information about the user held by the selected identity proofing solution.

14. The method of claim 5, wherein the biometric identifier is a physical identifier selected from the group consisting of: fingerprint, retina scan, palm vein scan, facial recognition scan, DNA scan, palm print, hand geometry scan, iris recognition scan, voiceprint, and odour/scent scan.

15. The method of claim 5, wherein the biometric identifier is a behavioural identifier selected from the group consisting of typing rhythm, gait, and speech pattern.

16. The method of claim 5, wherein the biometric identifier is selected by the requestor.

17. The method of claim 5, wherein the biometric identifier is selected based on detected capabilities of the user's device or devices connected to the user's device.

18. The method of claim 1, further comprising taking at least one post-validation step selected from the list consisting of:
allowing admission of the user to a place or event;
confirming or completing a transaction;
adding the user to a whitelist;
granting a particular status to the user; and
removing a restriction on the user.

19. A method for using consolidated approaches to validating the identity of a user, comprising:
receiving a request to match the user's identity to previously enrolled particulars of the user;
determining that the user's identity has not yet been validated;
determining whether the user is enrolled with any of a pre-selected list of identity proofing solutions; and if not:
prompting the user to provide a photograph or scan of an identification credential selected from a pre-approved list of identification credentials;
prompting the user to provide a selfie;
matching the selfie to a photograph on the identification credential within a threshold of confidence; and
validating the user's identity.

20. A system for using consolidated approaches for validating the identity of a user, comprising:
a requestor module programmed for receiving a request from a requestor to match the user's identity to previously enrolled particulars of the user; and
a consolidation module programmed for:
determining that the user's identity has not yet been validated; and
querying at least one identity proofing solution selected from a pre-populated list; and
a user module programmed for:
receiving an authentication token for the identity proofing solution in order to allow remote confirmation of the user's identity.

21. The system of claim 20, wherein the user module is further programmed for:
receiving an identifier from the user to be associated with the identity of the user.

22. The system of claim 21, wherein the identifier is a biometric identifier.

23. The system of claim 20, wherein the consolidation module is programmed for communicating a validation decision to the requestor without providing the requestor with information about the user held by the selected identity proofing solution.
